(19) United States
(12) Patent Application Publication
(10) Pub. No.: US 2018/0025521 A1
(43) Pub. Date: Jan. 25, 2018

(54) DYNAMIC MODULATION FOR NEAR EYE DISPLAY

(71) Applicant: ENT. SERVICES DEVELOPMENT CORPORATION LP, Tysons, VA (US)

(72) Inventors: William J. ALLEN, Corvallis, OR (US); Kas KASRAVI, Pontiac, MI (US)

(73) Assignee: ENT. SERVICES DEVELOPMENT CORPORATION LP, Tysons, VA (US)

(21) Appl. No.: 15/547,469

(22) PCT Filed: Jan. 30, 2015
(86) PCT No.: PCT/US2015/013705

§ 371 Date: Jul. 28, 2017

(51) Int. Cl. G06T 11/60; G06T 11/00

(52) U.S. Cl. CPC G06T 11/60; G06T 11/001; G06T 7/90

(57) ABSTRACT

In example implementations, an amount of ambient light in a real world image is measured. An analysis of the virtual image is performed and a user preference for the virtual image is determined. A brightness level of the real world image is modulated based upon the amount of ambient light in the real world image that is measured. The virtual image is adjusted to optimize an appearance of the virtual image on a near eye display that is overlaid on the real world image based upon the analysis of the virtual image, the real world image that is modulated and the user preference for the virtual image.

### BACKGROUND

In some near eye displays, a virtual image is superimposed or overlaid over a real world image. Examples of near eye displays include the Google® Glass Device®. For example, a user may view real world images and use the near eye display to provide additional information or other images that are overlaid over the real world image. Thus, the near eye display can provide two images within a user's view simultaneously. Often, the virtual image is difficult to see because the virtual image does not stand out from the real world image over which the virtual image is superimposed. High brightness real world situations are particularly challenging. The brightness of the real world image (e.g., looking at a blue sky or a white exterior of a building during the day) creates a difficulty in reading virtual text on the near eye display that is superimposed over the real world image.

In addition, near eye displays are inherently mobile and users may drastically change the viewing conditions simply by rotating the users' head or moving about. As a result, it is not possible to create a fixed high-quality optimization of a presentation of virtual images in the near eye display such that the user will enjoy a good viewing experience across a reasonable range of viewing conditions.

An additional complication is that different users may have different preferences. For example, some users may prefer a brighter image and other users may prefer a dimmer image. Furthermore, some users may have some color blindness and can only see images of a certain light frequency.

### BRIEF DESCRIPTION OF THE DRAWINGS

FIG. 1 is a block diagram of an example apparatus of the present disclosure;

FIG. 2 is an example of an unadjusted virtual image on an unmodulated real world image;

FIG. 3 is an example of an adjusted virtual image on a modulated real world image;

FIG. 4 is a flowchart of an example method for modulating a near eye display; and

FIG. 5 is a high-level block diagram of an example computer suitable for use in performing the functions described herein.

### DETAILED DESCRIPTION

The present disclosure broadly discloses a method and non-transitory computer-readable medium for modulating a near eye display. Often, with near eye displays a virtual image that is overlaid over a real world image is difficult to see because the virtual image does not stand out from the real world image over which the virtual image is superimposed. High brightness real world situations are particularly challenging. The brightness of the real world image (e.g., looking at a blue sky or a white exterior of a building during the day) creates a difficulty in reading virtual text on the near eye display that is superimposed over the real world image.

In addition, near eye displays are inherently mobile and users may drastically change the viewing conditions simply by rotating the users' head or moving about. As a result, it is not possible to create a fixed high-quality optimization of a presentation of virtual images in the near eye display such that the user will enjoy a good viewing experience across a reasonable range of viewing conditions.

An additional complication is that different users may have different preferences. For example, some users may prefer a brighter image and other users may prefer a dimmer image. Furthermore, some users may have some color blindness and can only see images of a certain light frequency.

Examples of the present disclosure provide a novel method for modulating a near eye display. In one example, the virtual image may be adjusted to optimize the virtual image that overlays the modulated real world image in the near eye display. In addition, the virtual image may be adjusted based upon user preferences for a brightness level of the virtual image or for distinguishability of the virtual image from the background image. As a result, the virtual image that is viewed by the user may be optimized to provide a more pleasant viewing experience.

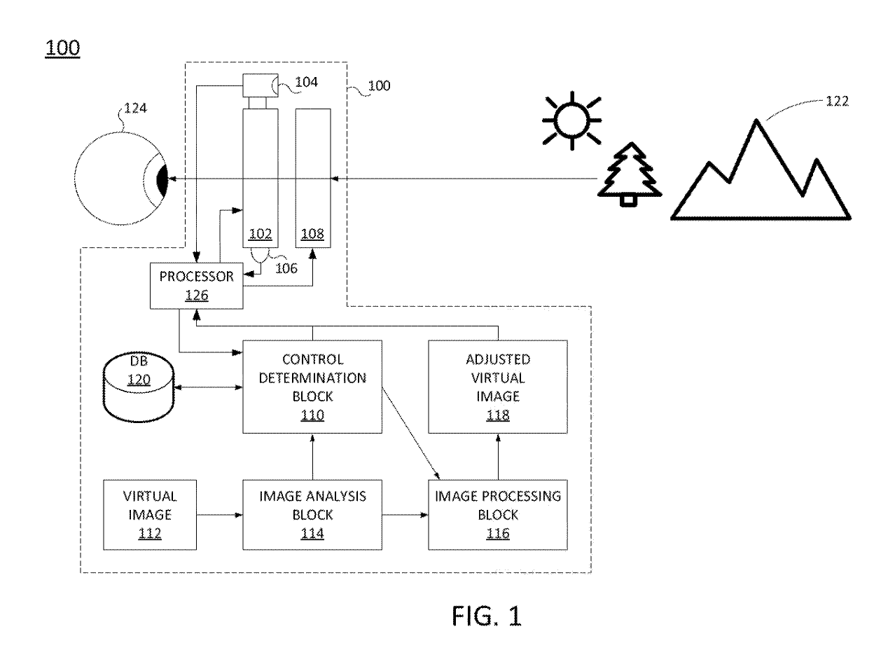

FIG. 1 illustrates an example apparatus 100 of the present disclosure. In some implementations, the apparatus 100 may be a head mounted video device. For example, the apparatus 100 may be a device (e.g., Google® Glass®) that a user may wear on his or her face or head. The apparatus 100 may include a near eye display (NED) 102, a video camera 104, an ambient light sensor 106 and an incoming light modulator 108. In one example, the NED 102, the video camera 104, the ambient light sensor 106 and the incoming light modulator 108 may be in coupled to or in communication with a processor 126. In one example, the NED 102 may be defined as any display that projects an image directly onto a retina 124 of a user or into an eyeball of the user. It should be noted that the NED 102 is not intended to cover traditional video screens, monitors or other displays where images are projected onto a distant screen and reflected off of the screen or surface.

In one example, the video camera 104 may be used to capture a real world image 122. In one example, the real world image 122 may be defined to be any image that is viewed by the user via the apparatus 100. In other words, the real world image 122 may be a reproduction of what a user is seeing or looking at via the apparatus 100. The captured video images of the real world image 122 may be used for analysis (e.g., color analysis, contrast analysis, brightness analysis, and the like). In one example, the ambient light sensor 106 may be used to measure a level of brightness of the real world image 122. In one example, the level of brightness may be measured in a unit of illuminance, such as for example, lux, lumens/square meter, and the like.

In one example, the video images captured by the video camera 104 and the measurements obtained by the ambient light sensor 106 may be fed to a control determination block 110 via the processor 126. In one example, only the measurements obtained from the ambient light sensor 106 may be fed to the control determination block 110. In other words, the video images captured by the video camera 104 may not be used in some analyses. The control determination block may analyze the video images and/or the measurements of the amount of ambient light and determine how much to modulate the real world image 122 via the incoming light modulator 108.

In one example, the control determination block may take an average of the ambient light measurements of the entire real world image 122 and compare the average to a threshold stored in a database (DB) 120. In one example, if the average of the ambient light measurements is above the threshold, the real world image 122 may be modulated. In one example, the control determination block may take an average of the ambient light measurements of different sub-regions of the real world image 122 and compare each sub-region to the threshold to determine if one or more of the sub-regions need to be modulated.

In one example, the incoming light modulator 108 may modulate the level of brightness of the real world image 122. It should be noted that the incoming light modulator 108 is different from, and/or in addition to, a light modulator that may be used within the NED 102, such as for example, liquid crystal on silicon light modulators that can be used in the NED 102. In one example, the light modulator 108 may be placed on a side of the near eye display 102 that is opposite the retina 124. In other words, the light modulator 108 would be the first optic that the light signals from the real world image 122 would pass through. In other words, the NED 102 may be located behind the light modulator 108.

In one example, the modulation may be performed by a mechanical mechanism or system or an electrical mechanism or system. In one example, the mechanical mechanism or system may be a mechanical filter, such as, for example, a filter wheel. Different filters having different levels of light modulation, for example different levels of light transmission, may be mechanically coupled together and passed in front of the near eye display 102. In one example the electrical mechanism or system may perform modulation based on a phase, a frequency, an amplitude or a polarity of the light signals of the real world image 122. For example, an electrically activated tunable multilayer interface may be deployed in front of the near eye display 102.

In some instances, modulating the light level or brightness of the real world image 122 may not be enough to provide an easier viewing experience of a virtual image 112 for the user. In one example, the virtual image 112 may be defined as an image that is generated by the apparatus 100. In other words, the virtual image 112 is not the same as what the user is seeing via the apparatus 100 and not the same as the real world image 122. For example, the virtual image 112 may be a computer generated text, graphic, video, photograph, and the like. As a result, examples of the present disclosure also analyze the virtual image 112 and adjust the virtual image 112 based on user preferences and the real world image 122 that is modulated to optimize the virtual image 112 when viewed on top of the real world image 122 that is modulated. In some examples, the virtual image 112 may be optimized to be viewed over the real world image 122 that is not modulated. For example, if the ambient light measurements of the real world image 122 are not above the threshold, then the real world image 122 may not be modulated.

In one example, the virtual image 112 may be analyzed by an image analysis block 114. In one example, the image analysis block may analyze the virtual image 112 to determine what type of image is contained in the virtual image 112. In one example, the different types of images may include a text image, a photographic image, a video image, a graphical image, and the like. The virtual image may also be analyzed for a level of brightness, color content, an amount of contrast, and the like.

The virtual image 112 may be analyzed because different types of images may require different adjustments when viewed over the real world image 122 that is modulated. For example, text may require less adjustment than a photograph that has many bright colors and contrasts when viewed over the real world image 122 that is modulated.

In one example, the results of the image analysis block 114 may be fed to the control determination block 110. The control determination block 110 may then adjust the virtual image 112 based upon one or more user preferences stored in the DB 120 and the real world image 122 that is modulated. In one example, the user preferences may include pre-defined brightness level settings, contrast level settings, settings for specific light frequencies or colors, if the user is color blind, and the like, defined by the user. In addition, the control determination block 110 may adjust the virtual image 112 to optimize the virtual image 112 when overlaid on the real world image 122 that is modulated, but also within the constraints set by the user preferences.

In one example, the control determination block 110 may also divide the virtual image 112 into different sub-regions. As a result, when different sub-regions of the virtual image 112 are overlaid on different sub-regions of the real world image 122 that have different modulation levels, the different sub-regions of the virtual image 112 may also be adjusted differently. For example, a sub-region of the virtual image 112 that is overlaid on a brighter sub-region of the real world image 122 may be adjusted to be brighter and/or have a higher contrast. In another example, a sub-region of the virtual image 112 that is overlaid on a darker sub-region of the real world image 122 may be adjusted to be lighter and having a lower contrast.

It should be noted that any type of image adjustment functions may be applied to the virtual image 112. In one example, the image adjustment functions may include a classic gamma function, a simple linear attenuation function, a sigmoid transfer function, and the like.

In one example, the adjustments to the virtual image 112 may be sent by the control determination block 110 to an image processing block 116. The image processing block 116 may process the virtual image 112 to apply the adjustments calculated by the control determination block 110 to create an adjusted virtual image 118. The adjusted virtual image 118 may then be sent to the processor 126 to be overlaid on the real-world image 122 via the NED 102.

In one implementation, the control determination block 110, the image analysis block 114 and the image processing block 116 may be implemented as hardware components including a processor. In one example, the processor 126 may execute instructions and functions stored in memory and associated with the control determination block 110, the image analysis block 114 and the image processing block 116.

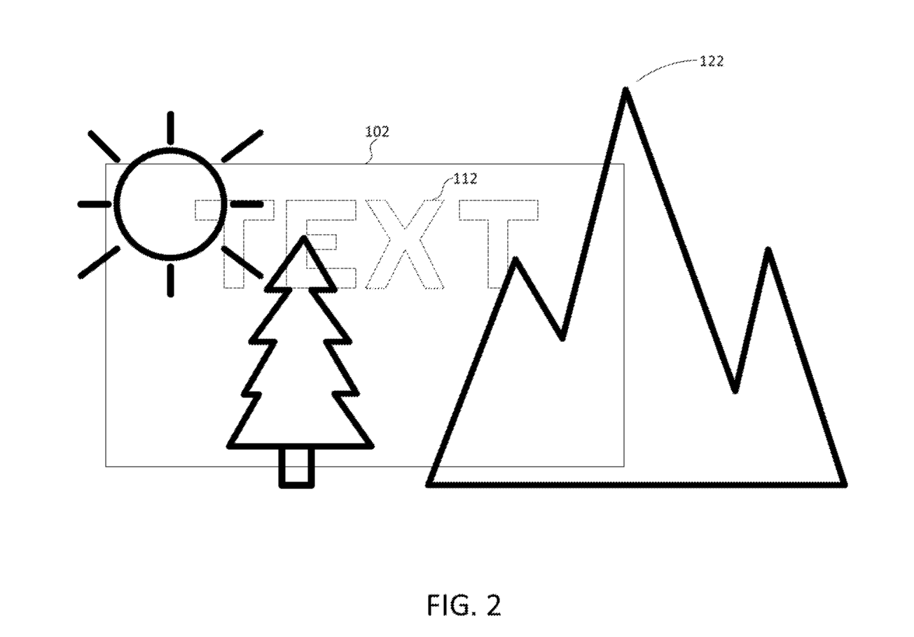

FIG. 2 illustrates an example of an unadjusted virtual image 112 on an unmodulated real world image 122 on the NED 102. For example, FIG. 2 is drawn from a perspective of a user wearing the apparatus 100 and viewing the NED 102 that overlays the virtual image 112 over the real world image. As shown in FIG. 2, the real world image 122 may be a bright outdoor scene on a sunny day that creates a difficulty in reading or see the virtual image 112 as shown by dashed lines.

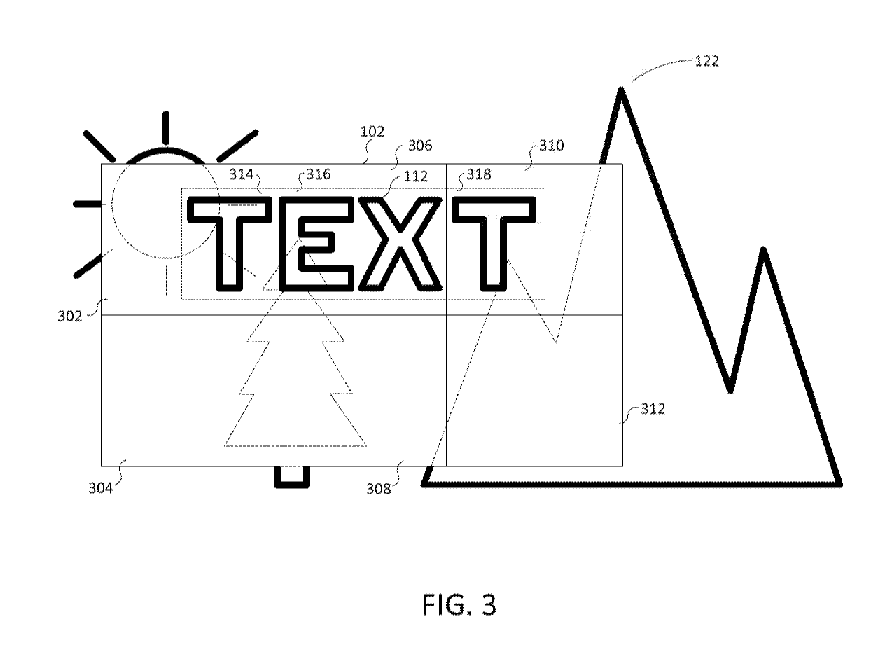

FIG. 3 illustrates an example of an adjusted virtual image 112 on a modulated real world image 122. For example, the real world image 122 is modulated to reduce the brightness of the real world image 122 within the NED 102. As a result, the virtual image 112 may be adjusted based on the real world image 122 for optimal viewing, as represented by the solid lines of the virtual image 112. The virtual image 112 may also be adjusted based on the user preferences. For example, the brightness, the color, the contrast, and the like, of the virtual image 112 may be adjusted.

In one example, the real world image 122 may be divided into different sub-regions 302, 304, 306, 308, 310 and 312, as discussed above. Although the sub-regions 302, 304, 306, 308, 310 and 312 are illustrated in a symmetrical grid form or a matrix, it should be noted that the sub-regions 302, 304, 306, 308, 310 and 312 may be arbitrarily shaped, irregularly located around the real world image 122, associated with a particular object or feature within the real world image 122, and the like.

One or more of the sub-regions 302, 304, 306, 308, 310 and 312 may have a different level of modulation due to different amounts of ambient light that is measured. For example, the sub-region 302 may include a portion of the sun and have the most amount of ambient light. As a result, the sub-region 302 may have the most modulation, e.g., incoming light attenuation in the present example, but may still be brighter than the other regions. In contrast, the sub-region 310 may include portions of darker leaves on the tree and the dark landscape of a mountain and have shading due to the trees and mountains. As a result, the sub-region 310 may have less modulation because the sub-region 310 has lower levels of ambient light and may be darker than the sub-region 302 even after modulation.

Similarly, the virtual image 112 may be divided into different sub-regions 314, 316 and 318, as discussed above. One or more of the sub-regions 314, 316 and 318 of the virtual image 112 may also have different adjustments depending on sub-regions 302, 304, 306, 308, 310 and 312 of the real world image 122 that the sub-regions 314, 316 and 318 are overlaid on top of. For example, the sub-region 314 of the virtual image 112 may require a low level of brightness, a darker color and/or higher contrast since the sub-region 314 is overlaid on the sub-region 302 that contains the sun and is the brightest. In contrast, the sub-region 318 of the virtual image 112 may require a higher level of brightness, a lighter color and/or a lower contrast since the sub-region 318 is overlaid on the sub-region 310 that includes the darker shades of the tree and the mountain. As a result, when a user views the virtual image 112, the virtual image 112 may have different adjustments across the virtual image 112 to allow the user to easily view the virtual image 112 on top of the different levels of brightness and modulation of the real world image 122.

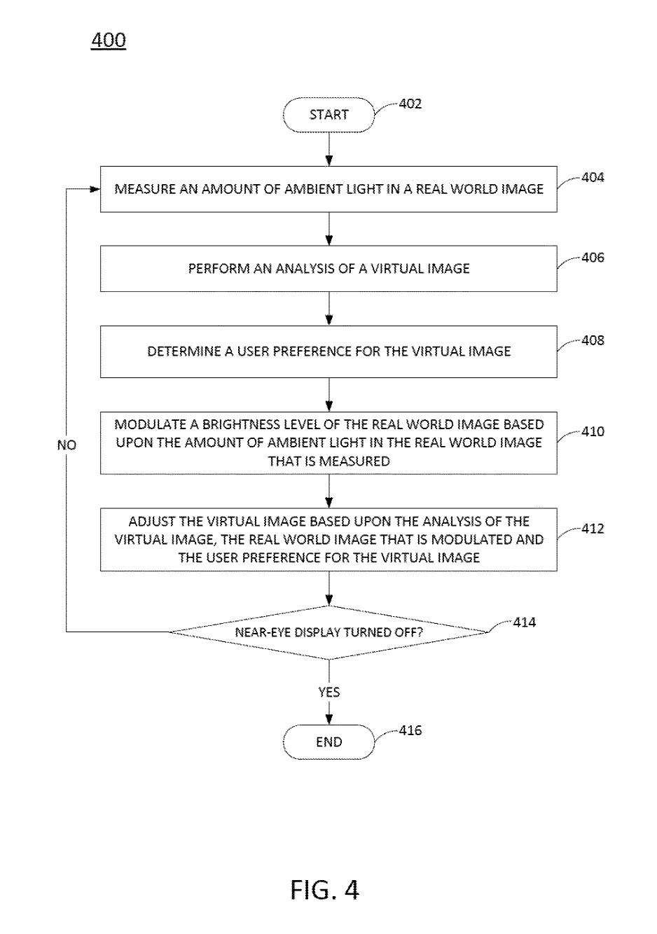

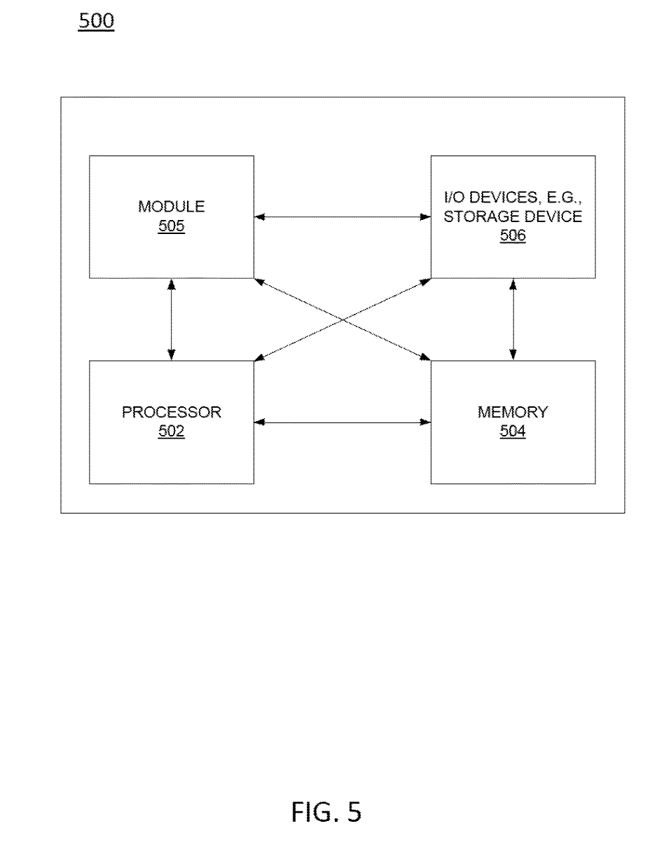

FIG. 4 illustrates a flowchart of a method 400 for modulating a near eye display. In one example, the method 400 may be performed by the apparatus 100 (e.g., a head mounted video device) or a computer as illustrated in FIG. 5 and discussed below.

At block 402 the method 400 begins. At block 404, the method 400 measures an amount of ambient light in a real world image. For example, an ambient light sensor on a head mounted video display device may measure an amount of ambient light in the real world image 122.

In one example, other characteristics of the real world image 122 may also be measured. For example, a video camera on the head mounted video display device may also capture video images of the real world image for analysis of color and contrast needed for modulation of the real world image 122.

At block 406, the method 400 analyzes the virtual image. For example, the virtual image 112 may be analyzed to determine a type of image contained in the virtual image 112. For example, the type of image may be at least one of: a text image, a photographic image, a video image, a graphical image, and the like.

At block 408, the method 400 determines a user preference for the virtual image. For example, the user may interface with the head mounted video display device and enter one or more user preferences for the virtual image. In one example, the one or more user preferences may include a brightness level of the virtual image, one or more preferred colors of the virtual image (e.g., the user may be color blind to certain colors), a contrast level of the virtual image, and the like.

At block 410, the method 400 modulates the real world image based upon the amount of ambient light. In one example, the amount of ambient light may be compared against a predefined threshold. If the amount of ambient light is above the threshold, the real world image may be modulated. If the amount of ambient light is below the threshold, the real world image may not need to be modulated.

In one example, the amount of ambient light may be an average of the entire real world image. In another example, the amount of ambient light may be an average within each sub-region of a plurality of different sub-regions within the real world image, as described above. The amount of ambient light within each sub-region may then be compared to the predefined threshold to determine whether one or more of the sub-regions should be modulated.

In one example, the modulation may be performed by any modulation methods or systems. For example, the modulation may be performed by mechanical systems or by electrical systems.

At block 412, the method 400 adjusts the virtual image based upon the analysis of the virtual image 112, the real world image 122 that is modulated and the user preference for the virtual image 112. In one example, the different types of images may include a text image, a photographic image, a video image, a graphical image, and the like. The virtual image may also be analyzed for a level of brightness, color content, an amount of contrast, and the like.

In one example, the virtual image may be analyzed because different types of images may require different adjustments when viewed over the real world image that is modulated. For example, text (e.g., broadly alphanumeric characters or symbols) may require less adjustment than a photograph that has many bright colors and contrasts when viewed over the real world image that is modulated. Thus, the type of virtual image may determine the types and amounts of adjustments to be applied to the virtual image 112.

In one example, any type of adjustment functions may be applied to the virtual image 112. Examples of the adjustment functions may include a classic gamma function, a simple linear attenuation function, a sigmoid transfer function, and the like.

In one example, blocks 410 and 412 may occur in parallel. In other words, although blocks 410 and 412 are illustrated in series, blocks 410 and 412 may occur at the same time in parallel.

At block 414, the method 400 determines if the NED is turned off. If the NED is turned off, then method 400 may proceed to block 416. At block 416, the method 400 ends.

However, if the method 400 determines that the NED is not turned off, then the method 400 may proceed to block 404 and repeat blocks 404-414. Since the NED is worn by the user, the user's head is constantly in motion and the real world image viewed through the NED will be changing continuously. As a result, the method 400 may continue to measure the amount of ambient light in the real world image to modulate the real world image, analyze the virtual image if the virtual image changes and adjust the virtual image as described above. In one example, the method 400 may maintain a continuous loop of measuring the ambient light, modulating the real world image, determining the user preference, analyzing the virtual image and adjusting the virtual image until the NED is determined to have been turned off at block 414.

As a result, the examples of the present disclosure improve the technology of near eye displays (e.g., on a head mounted video device). For example, functioning of the near eye display is improved by optimizing the viewing of the virtual image that is overlaid on the real world image. The functions described herein were not available on previous near eye displays.

It should be noted that although not explicitly specified, one or more blocks, functions, or operations of the method 400 described above may include a storing, displaying and/or outputting block as required for a particular application. In other words, any data, records, fields, and/or intermediate results discussed in the methods can be stored, displayed, and/or outputted to another device as required for a particular application. Furthermore, blocks, functions, or operations in FIG. 4 that recite a determining operation, or involve a decision, do not necessarily require that both branches of the determining operation be practiced.

FIG. 5 depicts a high-level block diagram of a computer that can be transformed to into a machine that is dedicated to perform the functions described herein. Notably, no computer or machine currently exists that performs the functions as described herein. As a result, the examples of the present disclosure improve the operation and functioning of a head mounted video device, as disclosed herein.

As depicted in FIG. 5, the computer 500 comprises a hardware processor element 502, e.g., a central processing unit (CPU), a microprocessor, or a multi-core processor; a memory or storage 504, e.g., random access memory (RAM) and/or read only memory (ROM); a module 505 for modulating a near eye display and adjusting a virtual image; and various input/output user interface devices 506 to receive input from a user and present information to the user in human perceptible form, e.g., storage devices, including but not limited to, a tape drive, a floppy drive, a hard disk drive or a compact disk drive, a receiver, a transmitter, a speaker, a display, a speech synthesizer, an output port, an input port and a user input device, such as a keyboard, a keypad, a mouse, a microphone, and the like. Although only one processor element is shown, it should be noted that the computer may employ a plurality of processor elements. Furthermore, although only one computer is shown in the figure, if the method(s) as discussed above is implemented in a distributed or parallel manner for a particular illustrative example, i.e., the blocks of the above method(s) or the entire method(s) are implemented across multiple or parallel computers, then the computer of this figure is intended to represent each of those multiple computers. Furthermore, one or more hardware processors can be utilized in supporting a virtualized or shared computing environment. The virtualized computing environment may support one or more virtual machines representing computers, servers, or other computing devices. In such virtualized virtual machines, hardware components such as hardware processors and computer-readable storage devices may be virtualized or logically represented.

It should be noted that the present disclosure can be implemented by machine readable instructions and/or in a combination of machine readable instructions and hardware, e.g., using application specific integrated circuits (ASIC), a programmable logic array (PLA), including a field-programmable gate array (FPGA), or a state machine deployed on a hardware device, a computer or any other hardware equivalents, e.g., computer readable instructions pertaining to the method(s) discussed above can be used to configure a hardware processor to perform the blocks, functions and/or operations of the above disclosed methods. In one example, instructions and data for the present module or process 505 modulating a near eye display and adjusting a virtual image, e.g., machine readable instructions can be loaded into memory 504 and executed by hardware processor element 502 to implement the blocks, functions or operations as discussed above in connection with the example method 400. Furthermore, when a hardware processor executes instructions to perform “operations”, this could include the hardware processor performing the operations directly and/or facilitating, directing, or cooperating with another hardware device or component, e.g., a co-processor and the like, to perform the operations.

The processor executing the machine readable instructions relating to the above described method(s) can be perceived as a programmed processor or a specialized processor. As such, the present module 505 for modulating a near eye display and adjusting a virtual image, including associated data structures, of the present disclosure can be stored on a tangible or physical (broadly non-transitory) computer-readable storage device or medium, e.g., volatile memory, non-volatile memory, ROM memory, RAM memory, magnetic or optical drive, device or diskette and the like. More specifically, the computer-readable storage device may comprise any physical devices that provide the ability to store information such as data and/or instructions to be accessed by a processor or a computing device such as a computer or an application server.

It will be appreciated that variants of the above-disclosed and other features and functions, or alternatives thereof, may be combined into many other different systems or applications. Various presently unforeseen or unanticipated alternatives, modifications, variations, or improvements therein may be subsequently made by those skilled in the art which are also intended to be encompassed by the following claims.

1. A method, comprising:
measuring, by a processor, an amount of ambient light in a real world image;
performing, by the processor, an analysis of a virtual image;
determining, by the processor, a user preference for the virtual image;
modulating, by the processor, a brightness level of the real world image based upon the amount of ambient light in the real world image that is measured; and
adjusting, by the processor, the virtual image to optimize an appearance of the virtual image on a near eye display that is overlaid on the real world image based upon the analysis of the virtual image, the real world image that is modulated and the user preference for the virtual image.

2. The method of claim 1, wherein the near eye display comprises a display that projects the virtual image onto a retina of a user.

3. The method of claim 1, wherein the user preference comprises: a brightness level, a preferred color or a contrast level.

4. The method of claim 1, wherein the analysis comprises determining a type of image.

5. The method of claim 1, wherein the modulating is performed via a mechanical system or via an electrical system.

6. The method of claim 1, wherein the adjusting comprises applying at least one of: a classic gamma function, a simple linear attenuation function or a sigmoid transfer function.

7. The method of claim 1, wherein the measuring the amount of ambient light in the real world image further comprises:
measuring, by the processor, the amount of ambient light in different sub-regions of the real world image.

8. The method of claim 7, wherein the adjusting the virtual image further comprises:
adjusting different sub-regions of the virtual image, wherein a different adjustment is performed in one or more of the different sub-regions of the virtual image to optimize each one of the different sub-regions of the virtual image that is overlaid on a corresponding one of the different sub-regions of the real world image.

9. An apparatus comprising:
an image analysis block to analyze a virtual image;
a database to store a user preference for the virtual image;
a control determination block in communication with the database and the image analysis block to determine an amount of modulation based on an amount of ambient light in a real world image that is measured by an ambient light sensor and to determine an adjustment for the virtual image to optimize an appearance of the virtual image on a near eye display that is overlaid on the real world image based upon the virtual image that is analyzed, the real world image that is modulated and the user preference for the virtual image; and
an image processing block in communication with the control determination block to process the virtual image in accordance with the adjustment.

10. The apparatus of claim 9, wherein the near eye display comprises a display that projects the virtual image onto a retina of a user.

11. The apparatus of claim 9, wherein the user preference comprise: a brightness level, a preferred color or a contrast level.

12. The apparatus of claim 9, wherein the image analysis block analyzes the virtual image to determine a type of image.

13. The apparatus of claim 9, further comprising:
a modulator in communication with the control determination block, wherein the modulator comprises a mechanical modulator or an electrical modulator.

14. The apparatus of 9, wherein the adjustment comprises applying at least one of: a classic gamma function, a simple linear attenuation function, or a sigmoid transfer function.

15. A head mounted video device, comprising:
a video camera to capture a real world image;
an ambient light sensor to measure an amount of ambient light in the real world image;
a processor coupled to the video camera and the ambient light sensor to perform an analysis of a virtual image, determine a user preference for the virtual image, determine an amount of modulation of a brightness level of the real world image based upon the ambient light in the real world image that is measured and adjust the virtual image to optimize an appearance that is overlaid on the real world image based upon the analysis of the virtual image, the real world image that is modulated and the user preference for the virtual image
a modulator coupled to the processor to modulate the real world image in accordance with the amount of modulation; and
a near eye display coupled to the processor and behind the modulator to display the virtual image that is optimized over the real world image that is modulated.
